(19) United States
(12) Patent Application Publication
(10) Pub. No.: US 2025/0172281 A1
(43) Pub. Date: May 29, 2025

(54) CONNECTING CABLE AND LIGHTING SYSTEM

(71) Applicant: KA SUEN CHAN, HONG KONG (CN)

(72) Inventor: KA SUEN CHAN, HONG KONG (CN)

(21) Appl. No.: 18/775,825

(22) Filed: Jul. 17, 2024

Related U.S. Application Data
(60) Provisional application No. 63/602,511, filed on Nov. 24, 2023.

(51) Int. Cl. F21V 23/06; F21V 19/00; F21V 23/00; F21Y 115/10

(52) U.S. Cl. CPC F21V 23/06; F21V 19/004; F21V 23/001; F21V 23/006; F21Y 2115/10

(57) ABSTRACT

The application discloses a lighting system. The lighting system includes a plurality of drive units and a plurality of connecting cables. Each of the connecting cables is individually connected to the drive unit to transmit control information and electrical energy to the drive unit, and the drive unit is configured to convert the electrical energy into corresponding target current and/or target voltage, according to the control information. The connecting cable includes a power transmission core configured to transmit electrical energy and a signal transmission core configured to transmit the control information; the power transmission core and the signal transmission core is positioned in close proximity to each other while being electrically isolated, and the control information is a digital signal.

### PRIORITY CLAIM

This application claims the benefit of and priority to Provisional Patent Application No. 63/602,511 filed on Nov. 24, 2023 and entitled “ThinkGrow Model One Integrated Cable System” which is hereby incorporated by reference in its entirety.

### TECHNICAL FIELD

This application relates to the field of artificial light source technology, particularly related to a connecting cable and a lighting system.

### BACKGROUND

With the continuous advancement of technology, artificial light sources have begun to be widely used in indoor spaces to address lighting issues. To meet the increasingly diverse usage needs, many lighting systems are equipped with numerous lighting units (e.g., LED strips).

Typically, lighting units require additional driving devices. The driving devices provide the appropriate working voltage to ensure the normal operation of the lighting units. In some cases, the driving devices may also need to receive control information from users or external controllers to control the lighting units to make corresponding changes (e.g., reducing or increasing the light intensity).

This complex transmission of signals and energy results in a lighting system requiring a huge number of cables. Excessive cables can severely affect the practical use of the lighting system, causing problems such as the inability to lay cables within an area and excessively high cable installation costs.

### SUMMARY

An embodiment of the application discloses a connecting cable. The connecting cable includes a power transmission core configured to transmit electrical energy and signal transmission core configured to transmit a control information; wherein the power transmission core and the signal transmission core are positioned in close proximity to each other, while being electrically isolated, and the control information is a digital signal.

Another embodiment of the application discloses a lighting system. The lighting system includes: a plurality of drive units; a plurality of connecting cables; wherein each of the connecting cables is individually connected to a corresponding one of the drive units to transmit a control information and an electrical energy to the drive unit, and the drive unit is configured to convert the electrical energy into corresponding target current and/or target voltage, according to the control information; wherein the connecting cable comprises a power transmission core configured to transmit the electrical energy and a signal transmission core configured to transmit the control information; the power transmission core and the signal transmission core is positioned in close proximity to each other while being electrically isolated, and the control information is a digital signal.

At least one advantageous aspect of the connecting cable and the lighting system according to the application is that the connecting cable integrates the power supply and communication line in one connecting cable, enabling simultaneous transmission of electrical energy and control information. The connecting cable significantly reduces the number of cables needed for multiple drive units. Moreover, the signal transmission core has sufficient anti-interference capabilities to ensure that control information can be effectively and accurately transmitted.

### BRIEF DESCRIPTION OF THE DRAWINGS

One or more embodiments are illustratively described with corresponding drawings. These illustrative descriptions do not limit the embodiments. Elements with the same reference numeral in the drawings are represented as similar components. Unless specifically stated, the drawings do not constitute a limitation on proportion.

FIG. 1 is a schematic diagram of the structure of the lighting system according to an embodiment of the application.

FIG. 2 is a schematic diagram of the structure of the lighting system from another perspective, according to the embodiment of the application.

FIG. 3 is a schematic diagram of the drive unit and the connecting cable according to the embodiment of the application.

FIG. 4 is a schematic diagram showing the connection between the drive unit and external devices, according to the embodiment of the application.

FIG. 5 is a cross-sectional view of the connecting cable according to the embodiment of the application.

### DETAILED DESCRIPTION

The detailed description of this application is provided below in conjunction with specific embodiments. It should be emphasized that the following description is merely illustrative and is not intended to limit the scope of the application or its applications.

It should be noted that unless explicitly defined and limited, the terms “center,” “longitudinal,” “transverse,” “upper,” “lower,” “vertical,” “horizontal,” “inner,” “outer,” and other directional or positional terms used in this specification are based on the directions or positions shown in the attached drawings. These terms are used merely for convenience in describing the application and simplifying the description, and do not imply that the devices or components referred to must have a specific orientation, be constructed and operated in a specific orientation, and thus should not be understood as limiting the application. The terms “mounted,” “connected,” “linked,” “fixed,” etc., should be understood broadly, for example, they could mean permanently connected or detachably connected, or integrally connected; they could be mechanical or electrical connections; they could be directly connected or indirectly connected through an intermediate medium. Moreover, the terms “first,” “second,” etc., are used only for descriptive purposes and should not be construed as indicating or implying relative importance or implicitly indicating the number of technical features indicated; thus, a feature defined as “first,” “second,” may explicitly or implicitly include one or more such features; “multiple” means two or more; “and/or” includes any and all combinations of one or more of the related listed items. For those skilled in the art, the specific meanings of these terms in this application can be understood based on the circumstances.

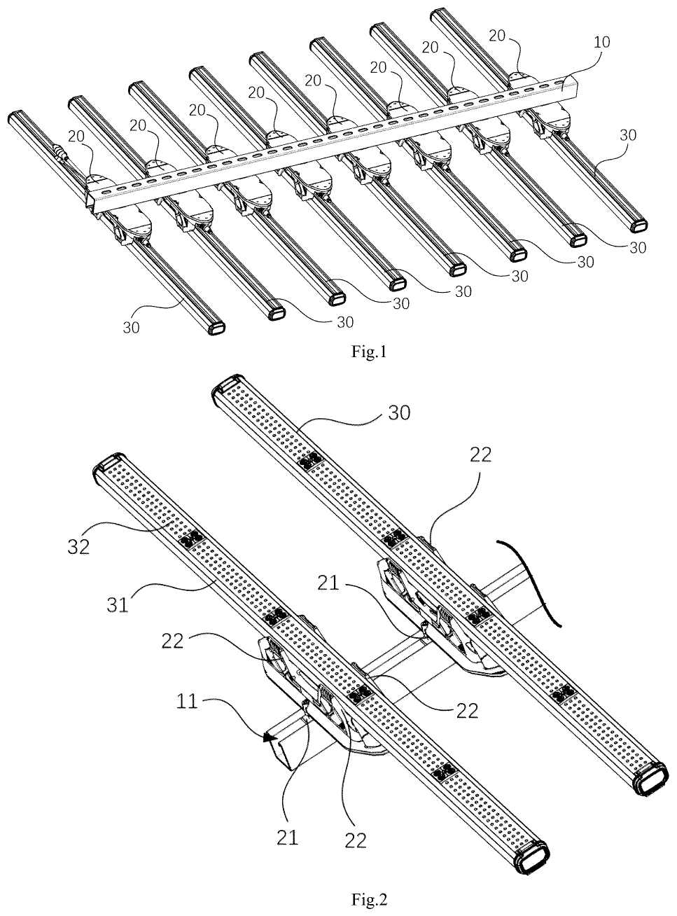

FIG. 1 is a schematic diagram of the structure of the lighting system according to an embodiment. As shown in FIG. 1, the lighting system includes a system bracket 10, several drive units 20 and several lighting units 30.

The system bracket 10 is a structural component used for support. It provides the basic structure of the lighting system and can be selected in any appropriate type, size, or material as needed. FIG. 1 exemplarily shows a long bar-shaped system bracket, which extends in a first direction for a predetermined length. The predetermined length can be determined as needed, such as the size of the lighting area, etc.

One lighting unit 30 is connected with one drive unit 20 to form a lighting component capable of emitting light. The drive unit 20 and the lighting unit 30 are fixedly connected in a detachable manner.

The term “detachable manner” means that the lighting unit 30, which is fixed to the drive unit 20, can be detached from the drive unit 20 as needed.

Specifically, as shown in FIG. 2, the drive unit 20 and the lighting unit 30 are connected through four elastically deformable latch structures 22. The latch structures 22 can greatly facilitate the installation and removal of the lighting unit 30, without the need for maintenance personnel to use specific tools.

In practical use, the lighting unit 30 can squeeze the latch structures 22 under the action of an external force, moving towards the drive unit 20. Once the lighting unit 30 moves into place, the latch structures 22 return to their original shape, fixing the lighting unit 30 on the drive unit 20.

In addition to mechanical fixation, there is also an electrical connection between the drive unit 20 and the lighting unit 30, enabling the drive unit 20 to provide the necessary working voltage and/or current to the lighting unit 30.

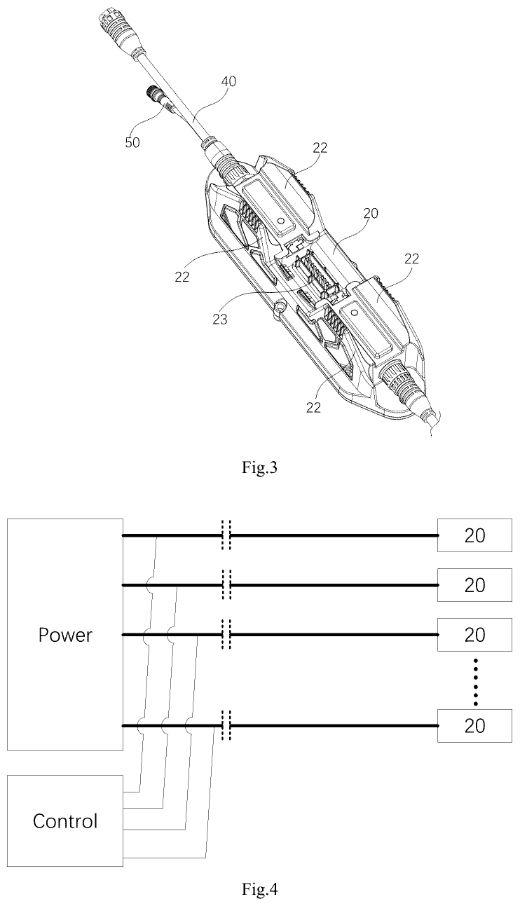

Specifically, as shown in FIG. 3, the surface of the drive unit 20 is provided with an electrical connector 23. The electrical connector 23 is composed of several pins arranged in a specific manner. When the lighting unit 30 is fixed to the drive unit 20, the electrical connector 23 can establish a tight and reliable physical contact with the corresponding electrical contacts of the lighting unit 30, thus establishing an electrical connection between the lighting unit 30 and drive unit 20.

Preferably, the lighting unit 30 has hot-swappable function to enhance system usability and maintenance flexibility. “Hot plugging” refers to the ability to safely insert or remove electronic equipment without turning off the system power or interrupting system operation.

Continuing with FIG. 1, each drive unit 20 is operatively connected to the system bracket 10 independently. The term “operatively connected” describes a type of connection between two structural components that allows for variable states. In other words, the drive unit 20 can remain relatively stationary or move freely relative to the system bracket 10.

Specifically, as shown in FIG. 2, the drive unit 20 is operatively connected with the system bracket 10 through a guiding mechanism composed of a rail 11 and a rail slider 21. The rail slider 21 is accommodated within the rail 11 and the drive unit 20 can move reciprocally along the first direction relative to the system bracket 10 under the action of the guiding mechanism.

In addition to being independently mechanically connected to the system bracket 10, each drive unit 20 is also connected to external devices through independent connecting cables, ensuring that each lighting component has the capability for independent control.

The external devices are electronic devices necessary for the normal operation and functioning of the lighting system. For example, a power source that provides electrical power to the lighting system and a main controller that provides control information to operate one or more lighting components in a desired state (such as the desired brightness).

As previously mentioned, since each drive unit 20 is connected to external devices using independent cables, each drive unit requires at least two cables, one connected to the power source and the other to the main controller, for transmitting electrical power and transmitting control information, respectively. Therefore, in cases where there are many drive units 20, the required number of cables is substantial.

For instance, in a setting with 800 drive units 20, 800 cables for transmitting electrical energy and 800 cables for transmitting control information would be needed. The total number of cables would reach 1600, posing significant challenges to the cable layout and installation of the lighting system.

During the implementation of this application, the applicant noted that when using a DC dimming control circuit based on analog signals (0-10V) to control light units (such as LED lights), the DC dimming control circuit is highly susceptible to external interference from other devices and power supply circuits, leading to inaccuracies in the transmission of control information. Consequently, it is not feasible to integrate signal transmission core and power transmission core into a single cable or to arrange them in close proximity.

Accordingly, an embodiment discloses a type of connection cable that can simultaneously transmit electrical energy and control information, aiming to reduce the number of connection cables needed by the lighting system as much as possible.

FIG. 3 illustrates a schematic diagram of the connection cable according to an embodiment of the application. As shown in FIG. 3, the connection cable includes a power transmission core 40 and a signal transmission core 50 that are positioned in close proximity to each other and electrically isolated.

The term “core” refers to a collection of two or more wires. Both the power transmission core 40 and the signal transmission core 50 can be composed of multiple wires to adequately meet the needs for power delivery and signal transmission.

“Close proximity to each other” is a term used to describe the spatial relationship between the power transmission core 40 and the signal transmission core 50. It indicates that the distance between the power transmission core and the signal transmission core is small enough to allow for electromagnetic interaction between them.

For example, when the power transmission core 40 and the signal transmission core 50 are wrapped together in a single sheath and appear to belong to a single cable, it can be considered that the power transmission core and the signal transmission core are close to each other.

“Electrically isolated” refers to the situation where there is no direct electrical connection between the power transmission core 40 and the signal transmission core 50. The electrical isolation between the power transmission core 40 and the signal transmission core 50 can be achieved in various ways.

For instance, an isolation layer made of non-conductive material may cover the outer surfaces of the power transmission core 40 and/or the signal transmission core 50, keeping the power transmission core 40 and the signal transmission core 50 separated by the non-conductive isolation layer.

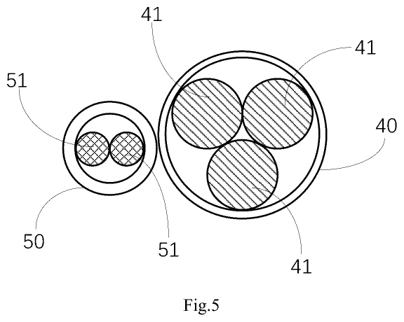

In practical use, as shown in FIG. 4, the power transmission core 40 of the connection cable forms a power supply circuit between the power source and the drive unit 20. The drive unit 20 can draw electrical energy from the power source through the supply circuit.

Specifically, the electrical energy is alternating current (AC) provided by the power source. The voltage of the AC can be set according to actual needs. For example, the AC voltage range could be from 100 to 277V, supporting the use of lighting components.

Within the connecting cable, the signal transmission core 50 establishes a communication connection between the main controller and the drive unit 20. Control information issued by the main controller can be transmitted through the communication core to specific target drive units, thereby changing the brightness of the lighting unit 30, turning on the lighting unit 30, or turning it off.

To ensure that the control information has sufficient anti-interference capability and to avoid electromagnetic effects from the high-voltage AC on the power transmission core, the control information is digital signals.

“Digital signal” refers to an electrical signal composed of discrete values. These discrete values are limited to a few fixed numbers and represented by different voltage levels. For example, the discrete values of a digital signal might include only 0 and 1, represented by high and low voltage levels, respectively.

Compared to the DC dimming control circuit based on analog signals, transmitting control information in the form of digital signals allows for accurate transmission of control information in environments with severe noise, such as near power supply cores, ensuring the safety and reliability of data transmission.

In some embodiments, the control information transmitted on the above communication core specifically complies with the RS485 communication protocol, using differential serial communication.

Specifically, as shown in FIG. 5, the signal transmission core 50 includes at least two smaller gauge first connection wires 51. One of the first connection wires serves as the positive transmission line, while the other serves as the negative transmission line, using differential signals to transmit the control information sent by the main controller.

Preferably, in addition to a pair of first connection wires 51, further structures such as a shielding layer could be added to enhance the performance of the signal transmission core 50.

Specifically, referring to FIG. 5, the power transmission core 40 for transmitting AC includes at least three larger gauge second connection wires 41. The three second connection wires can be used as the live wire L, neutral wire N, and ground wire G, respectively.

For ease of description, “first connection wire” and “second connection wire” are used to denote the wire that make up the power transmission core 40 and the signal transmission core 50.

The diameter of the wire indicates its capacity to tolerate current and voltage. Larger gauges can provide greater tolerance for current and voltage, which naturally also significantly increases the price and cost, and vice versa.

Thus, the second connection wire, which transmits electrical energy, can significantly have a larger gauge than the first connection wire, which are used for transmitting control information.

In the lighting system according to the embodiments described above, the digital communication protocols are used to transmit control information, thereby achieving dimming control functions for different lighting components. Communication connection based on the RS485 communication protocol is a long-distance transmission, while being less susceptible to interference from power supply cores.

Within each connecting cable, three wires of sufficient gauge are used to form the power transmission core, providing the electrical energy needed by the lighting components. Additionally, two smaller gauge wires are integrated to form the signal transmission core, which is used to transmit the RS485 signals.

In practical use, both the main controller and the power source are connected with each drive unit by one connecting cable. The connecting cable according to the embodiment described above power the drive units while simultaneously establishing communication connection between the drive unit and the main controller.

As a result, under the premise of the same number of drive units, the number of connecting cables required between the lighting system and external devices is significantly reduced. The significant reduction in the number of the connecting cables can effectively lower costs.

The above content is a further detailed explanation of this application in conjunction with specific/preferred embodiments and should not be construed as limiting the specific implementations to these descriptions. For those skilled in the art, several modifications and improvements can be made without departing from the concept of this application, and these are within the scope of protection of this application.

What is claimed is:

1. A connecting cable, comprising:
a power transmission core configured to transmit an electrical energy;
a signal transmission core configured to transmit a control information;
wherein the power transmission core and the signal transmission core are positioned in close proximity to each other, while being electrically isolated, and the control information is a digital signal.

2. The connecting cable according to claim 1, wherein the electrical energy transmitted by the power transmission core is alternating current (AC).

3. The connecting cable according to claim 2, wherein a voltage range of the alternating current is 100 to 277V.

4. The connecting cable according to claim 2, wherein the control information is a digital signal conforming to the RS485 communication protocol.

5. The connecting cable according to claim 4, wherein the signal transmission core comprises two first connection wires;
wherein the digital signal is transmitted by employing a differential signaling technique across the first two connection wires.

6. The connecting cable according to claim 4, wherein the power transmission core comprises three second connection wires;
wherein the alternating current is transmitted through the three second connection wires, and a diameter of the second connection wires is larger than that of the first connection wires.

7. A lighting system, comprising
a plurality of drive units;
a plurality of connecting cables;
wherein each of the connecting cables is individually connected to a corresponding one of the drive units to transmit a control information and an electrical energy to the drive unit, and
the drive unit is configured to convert the electrical energy into corresponding target current and/or target voltage, according to the control information;
wherein the connecting cable comprises a power transmission core configured to transmit the electrical energy and a signal transmission core configured to transmit the control information;
the power transmission core and the signal transmission core is positioned in close proximity to each other while being electrically isolated, and the control information is a digital signal.

8. The lighting system according to claim 7, wherein the electrical energy transmitted by the power transmission core is alternating current (AC), and the voltage range of the alternating current is 100 to 277V.

9. The lighting system according to claim 7, wherein the control information is a digital signal conforming to the RS485 communication protocol.

10. The lighting system according to claim 9, wherein the signal transmission core comprises two first connection wires;
wherein the digital signal is transmitted by employing a differential signaling technique across the first two connection wires.

11. The lighting system according to claim 10, wherein the power transmission core comprises three second connection wires;
wherein the alternating current is transmitted through the three second connection wires, and a diameter of the second connection wires is larger than that of the first connection wires.

12. The lighting system according to claim 7, wherein the lighting system further comprises:
a main controller communicatively connected to each of the drive units through the connecting cables;
a power source electrically connected to each of the drive units through the connecting cables.
